(19) United States
(12) Patent Application Publication
(10) Pub. No.: US 2009/0251937 A1
(43) Pub. Date: Oct. 8, 2009

(54) CIRCUIT ARRANGEMENT HAVING A DUAL COIL FOR CONVERTING A DIRECT VOLTAGE INTO AN ALTERNATING VOLTAGE OR AN ALTERNATING CURRENT

(76) Inventors: Heribert Schmidt, Freiburg (DE); Bruno Burger, Freiburg (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 12/158,802

(22) PCT Filed: Dec. 20, 2006
(86) PCT No.: PCT/EP06/12637

§ 371 Date: Oct. 29, 2008

(30) Foreign Application Priority Data
Dec. 23, 2005 (DE) 10 2005 062 845.1
Apr. 3, 2006 (DE) 10 2006 016 584.6

(51) Int. Cl. H02M 7/537

(52) U.S. Cl. 363/131

(57) ABSTRACT

The invention proposes a circuit arrangement for converting a DC voltage present at DC voltage terminals into an alternating current, which is supplied via AC voltage terminals, or an AC voltage, which circuit arrangement has a first series circuit, which is connected to the DC voltage terminals, comprises a first electronic switch (S₀) and an inductor, and has a plurality of second electronic switches (S₁, S₂), wherein one of the DC voltage terminals and one of the AC voltage terminals are connected to a neutral conductor (N/PE). The inductor is in the form of a twin inductor (DR₁) having two windings (W₁, W₂), which are arranged tightly coupled to one another, wherein the first winding (W₁) is connected in series with the first electronic switch (S₀) and buffer-stores the energy produced via said electronic switch. The two windings are each connected to the AC voltage terminal which is not connected to the neutral conductor via a second electronic switch (S₁, S₂).

The invention relates to a circuit arrangement for converting a direct voltage into an alternating voltage or an alternating current according to the preamble of the main claim.

Inverters for converting a direct (DC) voltage into an alternating (AC) voltage or an alternating (AC) current are known in general, a differentiation being made in the case of these inverters between inverters without galvanic separation, i.e. transformerless converters, and those with galvanic separation, i.e. transformer inverters. The highest efficiency is achieved with transformless inverters in a full-bridge circuit without step-up converters, such as are described for example in DE 102 21 592 A1. In the case of these circuits, the potential of the source with mains frequency and half mains voltage oscillates relative to earth potential. Hence a restriction exists in the applicability of these concepts in the case of sources with a high stray or leakage capacitance relative to earth potential, as is the case for example with solar generators of specific technology, in particular thin-film modules. In the case of conventional transformerless inverters without step-up converters, the input voltage range is delimited at the bottom by the voltage required at least for the supply at the level of the amplitude of the mains voltage, i.e. approx. 325 V with an effective (RMS) value of 230 V.

Furthermore, transformerless concepts are known, e.g. from DE 196 42 522 C1 and DE 197 32 218 C1, in which one terminal of the solar generator is connected rigidly to the neutral conductor and hence has a fixed potential relative to earth potential. As a result, even in the case of arbitrarily high leakage capacitances, in principle no leakage currents can flow.

In the case of DE 196 42 522 C1, a coil is connected in a first cycle portion via two switches to an input voltage which is buffered with an input capacitor and energy is stored in the coil. In the second cycle portion, according to the polarity of the voltage at an outlet capacitor which corresponds essentially to the mains voltage, a plurality of switches is configured such that the energy stored in the coil can be emitted via diodes and said switches to the output. It is of disadvantage with this known circuit arrangement that in total five switches are required. In the first cycle phase, two switches are always in the current path, in the second cycle phase during the positive half-wave, two switches and two diodes and, in the negative, two switches and one diode. As a result, high losses and correspondingly poor efficiency result. In addition, the switches together with the associated drives represent significant complexity and reduce the reliability. These inverters are hence distinguished by high complexity and hence poor efficiency, high cost and also reduced reliability.

The object therefore underlying the invention is to produce a circuit arrangement for converting a direct voltage into an alternating voltage or an alternating current from a direct voltage source which is unipolar relative to a neutral conductor, offers high efficiency, is based on simple, economical, reliable structures which are easily controllable with respect to control technology, and permits an input voltage range both below and above the mains voltage amplitude (typically 325 V with an effective value of 230 V).

This object is achieved according to the invention by the characterising features of the main claim in conjunction with the features of the preamble.

Advantageous developments and improvements are possible as a result of the measures indicated in the sub-claims.

As a result of the fact that the coil is configured as a dual coil with two windings which are disposed closely coupled to each other and the first winding is in series with the first electronic switch and the energy delivered via this switch is stored intermediately and that the two windings respectively are connected via a second electronic switch to the alternating voltage terminal which is not located on the neutral conductor, only three instead of five semiconductor switches are required. As a result, both efficiency and reliability are increased significantly. Furthermore, the omission of two switches in addition to the drive implies a notable saving in cost. The embodiment of the single coil with an additional winding represents merely a slight extra complexity.

It is advantageous that the windings of the dual coil have the same numbers of turns and are configured closely coupled to each other since the same voltage is consequently induced in both.

It is particularly advantageous that the windings of the dual coil are connected such that some of the respectively assigned winding ends are at rest potential (potential of the neutral conductor or of the instantaneous capacitor voltage at the output) and the others of the respectively assigned winding ends have the same voltage course offset by the value of the instantaneous capacitor voltage, as a result of which no cyclic charge reversal of the parasitic coupling capacitances between the windings is required and lower peak currents occur at the first switch and the efficiency and also the EMC behaviour are improved.

By provision of a capacitor between the winding ends with the same temporal voltage course, but offset by the value of the instantaneous output voltage, the energy stored in the unavoidable leakage inductances of the dual coil can be absorbed when opening the first switch and in the next cycle portion are transmitted almost loss-free to the output.

The circuit arrangement according to the invention can be configured also to be multiphase e.g. three-phase, for supplying into the normal public three-phase mains. Advantageously, a solar generator is used as direct voltage source, but also fuel cells, batteries or the like can also be used.

In an advantageous further development, the positive pole of the solar generator is connected to the neutral conductor, as a result of which all the modules or cells of the solar generator have a negative potential relative to earth potential, which has an advantageous effect on efficiency in the case of specific types of solar cells.

Advantageously, a plurality of input steps, comprising a first electronic switch, dual coil with assigned diodes and an input capacitor, is connected in parallel, which transmit the energy to the output offset in cycle. As a result, the ripple at the input capacitor is reduced and a sequential switching on of the input steps is possible as a function of the instantaneous power corresponding to a Master-Slave operation, as a result of which the efficiency course in the partial loading range is significantly improved.

Embodiments of the invention are represented in the drawing and are explained in more detail in the subsequent description. There are shown:

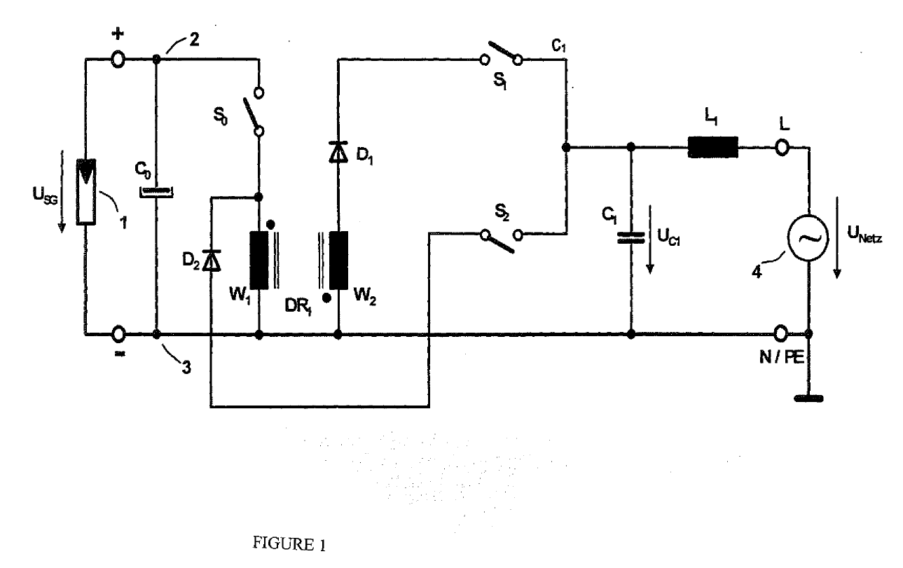

FIG. 1 the circuit-type configuration of a first embodiment of the invention,

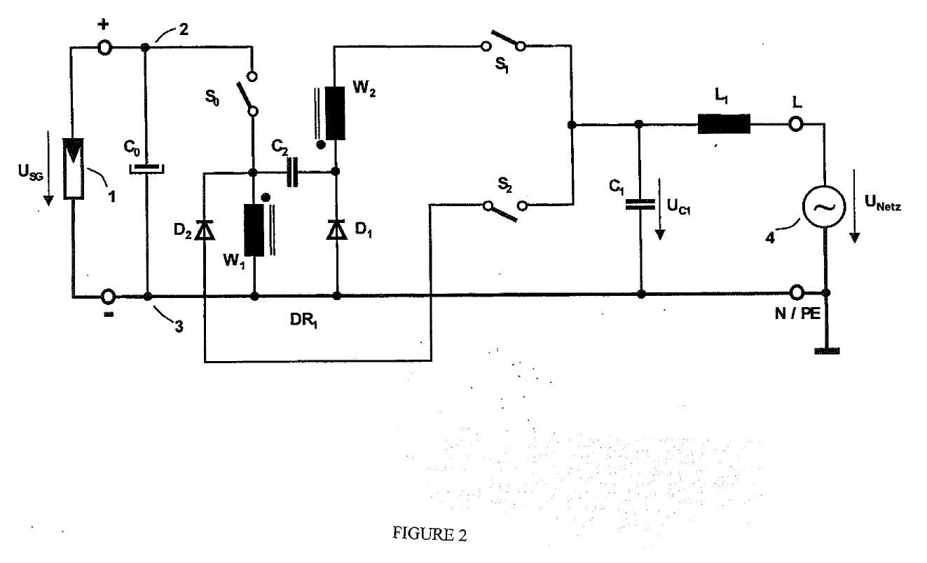

FIG. 2 the circuit-type configuration of a second embodiment of the invention,

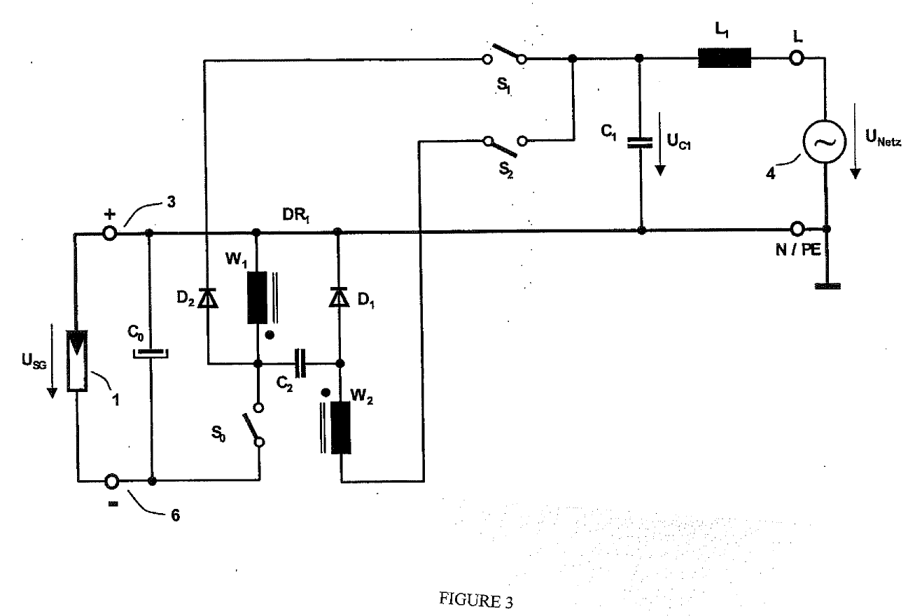

FIG. 3 the circuit-type configuration of a third embodiment of the invention,

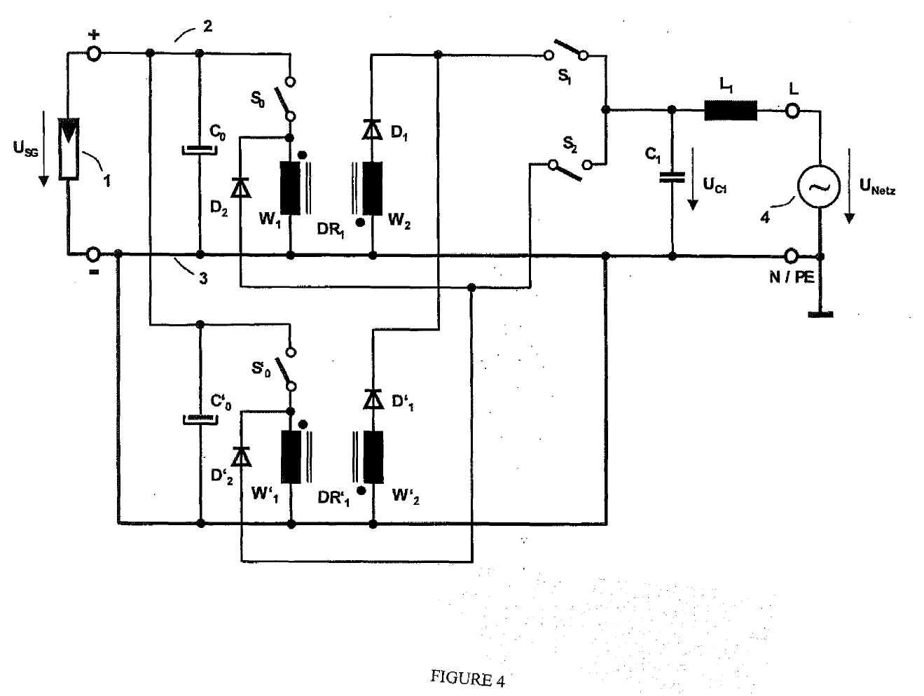

FIG. 4 the circuit-type configuration of a fourth embodiment of the invention with a plurality of input steps,

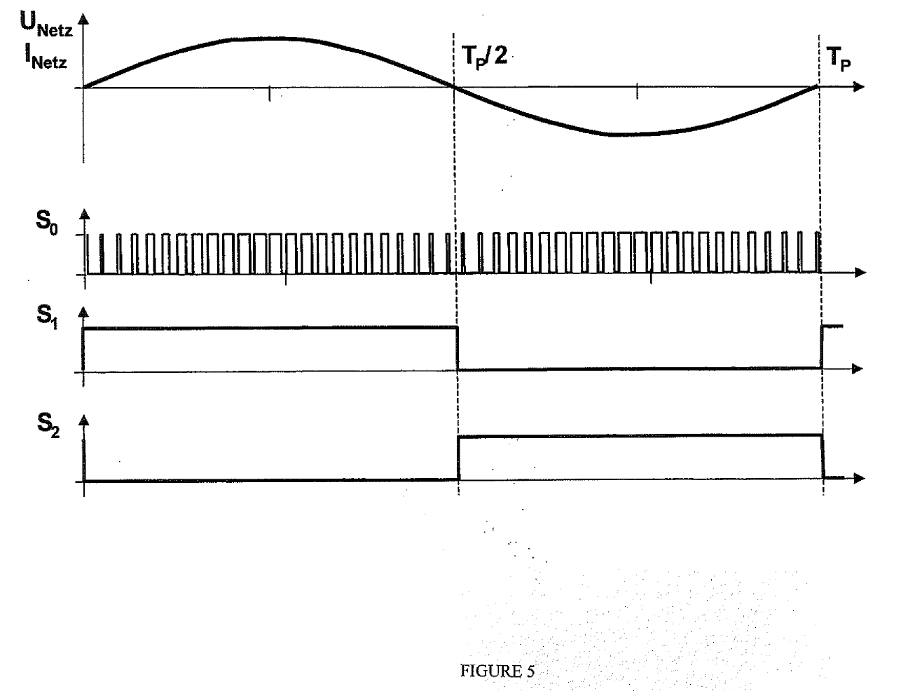

FIG. 5 diagrams of the pulse pattern occurring at the switches in FIGS. 1 to 3.

The circuit arrangement represented in FIG. 1 and configured as an inverter has a direct voltage source which, in the embodiment, is a solar generator 1 which is located with the terminals thereof on a positive line 2 and on a neutral or earth conductor 3. This solar generator delivers an input direct voltage U_{SG}.

A capacitor C₀ which buffers the input voltage U_{SG} is provided parallel to the solar generator 1. Between the lines 2, 3, there is located the series circuit of a first winding W₁ of a coil which is termed dual coil DR₁, and of a switch S₀ which is clocked by a control unit, not represented, and which can be configured as a transistor, preferably as a MOSFET or IGBT. The second winding W₂ of the dual coil DR₁ is connected by the winding start (the points on the windings W₁, W₂ characterise the winding starts thereof in the known manner) to the neutral conductor 3, the winding end being connected to a first diode D₁ which is in series with the switching path of an electronic switch S₁. At the connection point between first winding W₁ and the switch S₀, a second diode D₂ is connected which is in series with the switching path of an electronic switch S₂.

Windings W₁, W₂ supply, via the switches S₁ and S₂, an output capacitor C₁ which is connected by the one terminal thereof to the switches S₁, S₂ and which is located with the other terminal thereof on the neutral conductor 3. The voltage of the capacitor C₁ is characterised with U_{C1}. Capacitor C₁ and switches S₁ and S₂ are connected to a smoothing or supplying coil L₁, the other terminal of which is connected to one of the phases L of the mains 4, into which an alternating current is intended to be supplied, the mains voltage being termed Uₘₐᵢₙₛ. The neutral conductor 3 characterised with N/PE likewise forms an alternating voltage output terminal.

The dual coil DR₁ represents a transformer with energy storing properties, the galvanic separation of which is however not used in the present case. The winding W₁ is used doubly for supplying energy and for producing a voltage inverted relative to the potential of the neutral conductor 3. The winding W₂ serves to produce a voltage with the same polarity as the input voltage relative to the neutral conductor. The windings W₁ and W₂ advantageously have the same number of turns and are wound on a core closely coupled, said windings also being able to be wound in a bifilar manner.

The buffered input voltage U_{SG} is applied via the clocked switch S₀ to the first winding W₁ of the dual coil DR₁, as a result of which, in the first cycle phase in which the switch S₀ is in the On-state, a temporally increasing current is built up in the winding W₁, connected to an energy store in the magnetic circuit of the dual coil DR₁.

According to FIG. 5, the switch-on duration of the switch S₀ is adjusted via a control circuit, not shown here, (e.g. pulse width modulator PWM) such that, in the output coil L₁, a sinusoidal current is set which is then supplied into the public mains supply. As a function of the polarity of the capacitor voltage U_{C1}, which corresponds essentially to the mains voltage Uₘₐᵢₙₛ, the switches S₁ or S₂ are closed F according to FIG. 5. During the positive half-wave, S₁ is permanently closed and the energy stored in the dual coil DR₁ flows via the winding W₂, the diode D₁ and the switch S₁ into the output capacitor C₁. In the negative half-wave, the switch S₂ is correspondingly permanently closed and the energy flow is effected via the winding W₁, the diode D₂ and the switch S₂ into the output capacitor C₁. The energy emitted in this way in pulse form at the output capacitor C₁ is integrated up there to the voltage U_{C1} and supplied via the smoothing coil L₁ into the mains 4.

A further circuit arrangement is represented in FIG. 2 which differs from the circuit according to FIG. 1 in that the sequence within the series circuit of the winding W₂ of the dual coil DR₁ and of the diode D₁ is interchanged. This means that the diode D₁ is connected by the one terminal thereof to the neutral conductor 3 and, by the other terminal thereof, to the winding start of the winding W₂, the other terminal of which is connected to the switch S₁. In addition, a capacitor C₂ is connected respectively to the winding start of the winding W₁ and to the winding start of the winding W₂. Basically, the functional mode is as described previously, i.e. the general function remains unchanged. However, it is of advantage that both winding ends of the windings W₁, W₂ are at rest potential, i.e. at the reference potential which is prescribed by the neutral conductor 3 or at the instantaneous capacitor voltage U_{C1} applied to the capacitor C₁. The two winding starts have thus the same voltage course relative to each other, offset by the level of instantaneous capacitor voltage U_{C1}. Hence, the two windings W₁, W₂ can be wound very closely adjacent to each other, for example as a bifilar winding, since the parasitic coupling capacitance forming the between the two windings need not have a charge reversal at each cycle. From the spatially narrow construction there results a very good magnetic coupling of the windings W₁, W₂ and hence a low leakage inductance, an improved EMC behaviour and also lower switching losses in the switch S₀.

Since in the circuit according to FIG. 2, the two windings starts ideally have the same voltage course but offset by the value of the instantaneous output voltage, the two winding starts can be connected to the coupling capacitor C₂. This additional coupling capacitor C₂, when switching off the switch S₀, absorbs a part of the energy stored in the primary-side leakage inductance of the dual coil DR₁ and emits this in the next cycle via the winding W₂ during the positive half-wave to the output. As a result, excess voltages during the switching process are limited. In the negative half-wave, limiting is effected via the diode D₂ and the then closed switch S₂.

The circuits according to FIGS. 1 and 2 can also have a complementary construction. FIG. 3 shows by way of example the complementary construction of the circuit according to FIG. 2.

In FIG. 3, the positive terminal of the direct voltage source 1, i.e. of the solar generator, is located on the neutral conductor 3. This has the advantage that all the modules of the solar generator 1 have a negative potential relative to earth potential, which has an advantageous effect on the efficiency thereof with specific types of solar cells. Furthermore, the switch S₀ is located in the negative voltage supply line 6, which simplifies its actuation with respect to circuit technology, in particular if a plurality of parallel-operating input steps is provided.

As already mentioned, preferably MOS-FETs or IGBTs of the N-channel type are used as switches. N-channel transistors require a positive gate voltage of e.g. 15 volt relative to the emitter potential for actuation, for which purpose an auxiliary voltage must be made available. If a plurality of transistors with their emitters is at the same potential, a common auxiliary voltage source can advantageously be used.

In FIG. 4 there is provided a circuit arrangement corresponding to FIG. 1 with a plurality of input steps comprising the capacitor C₀, the switch S₀, the dual coil DR₁, the diodes D₁, D₂, only a second input step being represented in the drawing, the reference numbers of which are the same as in the first input step but are provided with a dash. If a circuit arrangement according to FIG. 2 or FIG. 3 is provided, the coupling capacitor C₂ also belongs to the input step. The input steps are all respectively connected to the switch S₁ or the switch S₂ and are supplied from the same source.

Advantageously, the associated switches S₀ or S₀′ are thereby clocked in a temporally offset manner so that both at the input, i.e. at the respective capacitors C₀, C₀′, and at the output, a comparable power flow is produced. Furthermore, a so-called Master-Slave operation is possible, in which the individual input steps are switched on as a function of the power to be transmitted instantaneously. As a result, the efficiency course can be significantly improved, in particular in the partial load range.

If a plurality of input steps is present, then these can also have separate input terminals which in turn can be connected to associated, even different, solar generators or other direct voltage sources.

1. Circuit arrangement for converting a direct voltage which is present at direct voltage terminals into an alternating current or an alternating voltage which is emitted via alternating voltage terminals, having a first series circuit which is connected to the direct voltage terminals and comprises at least one electronic switch and a coil and a plurality of second electronic switches, one of the direct and one of the alternating voltage terminals being located on a neutral conductor,
characterised in that
the coil is configured as a dual coil (DR₁) with two windings (W₁, W₂) which are disposed closely coupled to each other, the first winding (W₁) being in series with the first electronic switch (S₀) and intermediately storing the energy delivered by the latter, and both windings (W₁, W₂) respectively being connected via a second electronic switch (S₁, S₂) to the alternating voltage terminal which is not located on the neutral conductor.

2. Circuit arrangement according to claim 1, characterised in that the two second electronic switches (S₁, S₂) respectively are in series with a diode (D₁, D₂) and a winding of the dual coil (DR₁).

3. Circuit arrangement according to claim 1, characterised in that a storage capacitor (C₁) is connected in parallel to the alternating voltage terminals.

4. Circuit arrangement according to claim 1, characterised in that the windings (W₁, W₂) of the dual coil (DR₁) have the same numbers of turns.

5. Circuit arrangement according to claim 1, characterised in that the windings of the dual coil (DR₁) are bifilar windings.

6. Circuit arrangement according to one of the claim 3 to 5 claim 3, characterised in that the first switch (S₀) is clocked, and in that, in the one switching phase, energy storage takes place in the magnetic circuit of the dual coil (DR₁) and, in the other switching phase, a voltage is induced in both windings (W₁, W₂) in such a manner that, via the second switches (S₁, S₂), respectively a charging current flows into the capacitor (C₁).

7. Circuit arrangement according to one of the claim 1, characterised in that the windings of the dual coil (DR₁) are connected such that some of the terminals of the windings (W₁, W₂) termed winding ends are at rest potential and the other terminals termed winding starts have the same temporal voltage course.

8. Circuit arrangement according to claim 7, characterised in that the winding starts of the windings (W₁, W₂) of the dual coil (DR₁) are connected to each other via a coupling capacitor (C₂).

9. Circuit arrangement according to claim 7, characterised in that the first winding (W₁) is connected on the one side to the neutral conductor (3) and on the other side via a diode (D₂) to one of the second switches (S₂), and the second winding (W₂) is located on the one side via a diode (D₁) on the neutral conductor (3) and on the other side is connected to the other of the second switches (S₁).

10. Circuit arrangement according to claim 1, characterised in that that a solar generator (1), preferably with a plurality of modules, a fuel cell and/or a battery is connected to the direct voltage terminals.

11. Circuit arrangement according to claim 1, characterised in that the direct voltage source, which is configured as a solar generator (1), is connected by the negative terminal thereof to the neutral conductor (3) and all the modules of the direct voltage source have a positive potential relative to the neutral conductor (3).

12. Circuit arrangement according to claim 1, characterised in that the direct voltage source configured as solar generator (1) is connected by the positive terminal thereof to the neutral conductor (3) and all the modules of the direct voltage source have a negative potential relative to the neutral conductor.

13. Circuit arrangement according to claim 1, characterised in that a plurality of input steps, comprising first electronic switch (S₀), dual coil (DR₁) and assigned diodes (D₁, D₂) and possibly coupling capacitor (C₂), is present and supply into a common storage capacitor (C₁) via the second switches (S₁, S₂).

14. Circuit arrangement according to claim 13, characterised in that the individual input steps are connected in parallel and can be switched on as a function of the power to be transmitted instantaneously.

15. Circuit arrangement according to claim 13, characterised in that the plurality of input steps can be used independently of each other and are supplied possibly at the same time from different sources, such as solar generators, fuel cells or batteries.
